(19) United States
(12) Patent Application Publication
(10) Pub. No.: US 2003/0215129 A1
(43) Pub. Date: Nov. 20, 2003

(54) Testing liquid crystal microdisplays

(75) Inventors: Qingsheng J. Yang, Tempe, AZ (US); Dan D. Hoffman, Apache Junction, AZ (US); Peter A. Smith, Chandler, AZ (US); Mathias Pfeiffer, Mesa, AZ (US)

Correspondence Address: BAKER BOTTS, LLP, 910 LOUISIANA, HOUSTON, TX, 77002-4995, US

(73) Assignee: THREE-FIVE SYSTEMS, INC.

(21) Appl. No.: 10/313,178

(22) Filed: Dec. 6, 2002

Related U.S. Application Data
(60) Provisional application No. 60/380,662, filed on May 15, 2002.

(51) Int. Cl. G06K 9/00; H04N 7/18; G02F 1/13

(52) U.S. Cl. 382/149; 348/126; 349/192

(57) ABSTRACT

By rendering a special test image and applying flat-field correction for a device under test (DUT) non-uniformity, the E-O response of a reflective LCOS microdisplay can be quickly determined through an image processing algorithm. The measurement is made in a spatial domain instead of in a temporal domain. From the measurement, the driving voltage of maximum brightness, Vbright, can be determined. The use of Vbright enhances the visibility of pixel and sub-pixel defects to the test system. Other defect visibility enhancements are achieved through appropriate sampling rate, optical axis rotation and improved parallelism between the DUT and the CCD sensor camera. By modeling a sub-pixel defect as a local non-uniformity, a near neighborhood algorithm may be used for detection. The neighborhood algorithm does not rely on the alignment between the display pixels and the camera pixels.

### RELATED PATENT APPLICATION

This application claims priority, pursuant to 35 U.S.C. § 119(e), to commonly owned U.S. Provisional Patent Application Serial No. 60/380,662, entitled “Method and Algorithm for Fast Mesurement of the Electro-Optical Response for Liquid Crystal on Silicon Microdisplays” by Qingsheng J. Yang, Peter A. Smith and Mathias Pfeiffer, filed May 15, 2002, and is hereby incorporated by reference herein for all purposes.

### FIELD OF THE INVENTION

The present invention relates generally to evaluation of liquid crystal microdisplays, and more particularly to evaluation of the electro-optical (E-O) response of the microdisplay.

### BACKGROUND OF THE INVENTION TECHNOLOGY

Liquid crystal (LC) displays are commonly used in devices such as portable and large screen projection televisions, portable computers, computer monitors, control displays, and cellular phones to display information to a user. LC displays act in effect as light valves, i.e., they allow transmission of light in one state, block the transmission of light in a second state, and some include several intermediate stages for partial transmission. When used as a high resolution information display, LC displays are typically arranged in a matrix configuration with independently controlled pixels. Each individual pixel is controlled so as to selectively transmit or block light from a backlight (transmission mode), from a reflector (reflective mode), or from a combination of the two (transflective mode). Such LC displays are actuated pixel-by-pixel, either one at a time or a plurality simultaneously. A voltage is applied to each pixel area by charging a capacitor formed in the pixel area. The twisted liquid crystals respond to the charged voltage of the pixel capacitance by untwisting and thereby transmitting a corresponding amount of light.

A LC display is a light passive device which can only control the amount of light transmitted therethrough (transmission mode) or therefrom (reflective mode). Generally, the monochrome resolution of a LC display can be defined by the number of different levels of light transmission or reflection that each pixel can perform in response to a control signal. A second level is different from a first level when a user can tell the visual difference between the two. A LC display with greater monochrome resolution will look clearer to the user.

Several monochrome LC displays may be used in combination to produce a color display. When individual monochrome red, green and blue LC displays project their images in alignment onto a screen, the combination image will be in full color.

LC display technology has reduced the size of displays from full screen sizes to minidisplays less than 1.3 inches diagonal measurement, to microdisplays that require a magnification system. Some microdisplays include over two million pixels in an area of less than one square inch. Microdisplays may be manufactured using semiconductor integrated circuit (IC) dynamic random access memory (DRAM) process technologies.

The microdisplays consist of a silicon substrate backplane, a cover glass and an intervening liquid crystal layer. The microdisplays are configured as a matrix of pixels arranged in a plurality of rows and columns, wherein an intersection of a row and a column defines a position of a pixel in the matrix. To incident light, each pixel is a liquid crystal cell above a reflecting mirror. By changing the liquid crystal state, the incident light can be made to change its polarization. The silicon backplane is an array of pixels, typically 9 to 20 microns in pitch. Each pixel has a mirrored surface that occupies most of the pixel area. The mirrored surface is also an electrical conductor that forms a pixel capacitor with the ITO layer as the other plate of the pixel capacitor (common to all pixel capacitors in the matrix of pixels. As each pixel capacitor is charged to a certain voltage, the liquid crystals between the plates of the pixel capacitors “untwist” proportional to this voltage which affects the polarization of the light incident to the pixels (reflections from the pixel mirrors).

In the manufacture of LC microdisplays having relatively small size pixels, a number of usable LC devices and some unusable LC devices are produced. For example, some devices may have a number of pixels that are not connected for voltage actuation and therefore the light transference characteristics of the unconnected pixels cannot be adjusted. For another example, the liquid crystal itself may not be properly oriented such that even when voltages are applied, the correct transference characteristics do not occur. Therefore it is important to test LC microdisplays so as to determine whether their pixels will operate properly in displaying video images in accordance with the voltages that correspond to an input video signal. The test is commonly carried out for each microdisplay device, i.e., 100% inspection.

Microdisplays can generally be tested for nonconformity in four categories: electrical, optical, pixel and mechanical. There are differeces between on-line production tests and off-line lab tests. High volume production tests require fast verification of some of key display performances in those four categories within a certain set of defined parameters, whilst research and development lab tests usually take a full suite of characterization measurements. The production tests are selected based on their relevance, simplicity and cycle time. Some tests lend themselves well to production testing, especially when a desired measurement can be taken at fast speed.

The electro-optical (E-O) response of a LC microdisplay is a fundamental measurement of the display's optical performance. One of the most important of the specifications for a liquid crystal microdisplay product is the brightness versus a driving voltage, in particular, the maximum brightness and its correspondent driving voltage, Vbright, or a percentage of the maximum brightness and its corresponding driving voltage, which may, for example, correspond to LC reverse tilt loop.

Existing methods of measuring maximum brightness and it's Vbright is to step through a range of driving voltages Vi, i=0 . . . n, while taking multiple brightness measurements R(Vi). Next a search is performed for the maximum value Rmax in the measured brightness data R(Vi), i=0 . . . n, so as to obtain the correspondent Vbright. In single detector based measuring systems, the microdisplay device under test is typically driven in the global addressing mode, i.e., the whole display acts like a single huge pixel. In an area detector such as a CCD sensor based camera measurement system, the microdisplays are controlled through a driving electronics board adapted for video inputs. Gamma tables in the driving electronics transforms an input video gray shade into a corresponding driving voltage in a one-to-one mapping. Therefore, the stepped through voltage ranges are applied by displaying multiple solid gray images with different gray shades. At each driven gray shade a camera image is taken and the brightness measurement is calculated as an average intensity from the center part of the camera image. The calculation may also take into account calibration of the camera.

A major drawback to this method of testing LC microdisplays is the slow speed in making a complete measurement. Typically, 255 solid gray images with one gray shade per step are displayed and 255 camera images with one step per gray image are taken for the measurement. If the desired E-O response can be predicted in a small range, fewer images are needed. Still, the repetition of the “show-and grab” takes so long that the time for measurement is prohibitive in production real-time testing.

The textural and pictorial contents of microdisplays are normally magnified a number of times for viewing, e.g., 75 times in projection applications. Accordingly small defects in the display will be enlarged so much that the defects will adversely affect the display quality. Display pixel defects are those that the minimum size of the defects is of the same size as a display pixel, whilst sub-pixel defects are those defects which are smaller than the size of a display pixel.

An important test for mass production of LC microdisplays involves finding those defects that would render a microdisplay unusable for its intended application. The real challenge in pixel-level defect testing is not in locating or measuring pixel-sized defects. Rather, the true technical hurdles reside in the measurement of sub-pixel-sized defects that are not much different from the black, white, or gray background employed. An additional complication originates from the differences between the microdisplay device behavior in the test system compared to operation of the microdisplay in an actual operating application.

There is no known prior production tester that reliably inspects sub-pixel defects for LCOS microdisplays. There are LCOS microdisplay testers which incorporate a pixel defect test at some sampling rate such as 16 camera pixels to one device pixel. The algorithm for pixel defect detection maps a display pixel from 16 sensor pixels, i.e., locates 4×4 camera pixels which correspond to a display pixel and represents the display pixel with a value calculated from the 16 sensor pixel values. This single value is typically an average of the sensor pixel intensities. Sub-pixel information is lost through the calculation. Simple increases in the frequency of sampling are insufficient to test sub-pixel defects reliably.

For OLED direct view displays, there is a known method that inspects the fill-factor of each display pixel. The fill-factor inspection may detect sub-pixel defects. The pixel size for OLED is typically 300 μm˜500 μm which is much larger than the pixel size of LCOS microdisplays. The fill-factor inspection relies on the very large sampling rate and on the alignment between the camera pixel and the display pixel so to discount the effect from the relatively large inter-pixel gaps.

### SUMMARY OF THE INVENTION

The present invention overcomes the above-identified problems as well as other shortcomings and deficiencies of existing technologies by providing a CCD sensor based camera testing system for determining LC microdisplay defects. Instead of having to display and record multiple (e.g., 255) camera images, the present invention uses a gray shade chart test image and may use a solid color, e.g., white, light gray, etc., test image in combination with the gray shade chart test image for normalizing a global region of interest (ROI) to be tested. In addition, a flat field correction may be performed after normalization of the global ROI. Thus the camera need grab only the gray shade chart test image if normalization is not required, or the gray shade chart test image and solid color test image if normalization is required. Then the E-O response, Vbright and its brightness are computed with an image processing algorithm based on just the one or two grabbed images.

The image processing for grabbing one or two camera images may be performed with a standard computer system and the computation time is easily faster than the time required to show-and-grab multiple of images. Compared with the existing method that has to wait while obtaining a large number of test data images, the present invention measures the E-O response of LCOS microdisplays at a much faster speed. This technical advantage of the present invention allows the E-O response measurement to be used in production testing. The accuracy of the present invention is as good as the aforementioned prior test method which required many more images to be taken and evaluated.

Normalizing the images (gray shades and solid color) and performing a flat field correction thereof is not needed when the LC microdisplay is substantially uniform across a global ROI. For a substantially uniform LC microdisplay, according to an exemplary embodiment of the invention, a method of fast electro-optical (E-O) response measurement for liquid crystal microdisplays, comprises the steps of: loading a gamma table into a display drive electronics, the display drive electronics being adapted for driving a liquid crystal microdisplay under test, the gamma table being appropriate for the liquid crystal microdisplay under test; displaying a test image of a gray shade chart on the liquid crystal microdisplay under test, the gray shade chart having a plurality of gray shades; grabbing a camera image of the gray shade chart test image displayed on the liquid crystal microdisplay under test; locating a global region of interest (ROI) from the grabbed gray shade chart test image, wherein the global ROI represents an entire active area of the liquid crystal microdisplay under test; computing gray zone locations by combining the location of the global ROI with locations of the plurality of gray shades; placing a local ROI within each of the gray zone locations; calculating an average gray level intensity, Bi, for each of the gray zone locations; and calculating an equivalent driving voltage from each of the gray zone locations, their respective gray shades and the gamma table so as to obtain a set of electro-optical (E-O) response measurement values.

This exemplary embodiment may further comprise the step of determining a required driving voltage for a gray level intensity by using the set of E-O response measurement values.

The steps of the exemplary embodiment may further use a gray shade chart test image having a plurality of gray shades closer to a gray level intensity range of interest.

When the LC microdisplay is not substantially uniform, the exemplary embodiment of the present invention may further comprise the steps of: displaying a solid color test image on the liquid crystal microdisplay under test; grabbing a camera image of the solid color test image displayed on the liquid crystal microdisplay under test; normalizing the grabbed gray shade chart test image with the grabbed solid color test image; and performing a flat field correction with the normalized image. The solid color may be substantially white, substantially light gray, etc. The gray shade values corresponding to the grabbed gray shade chart test image may be stored in a matrix I(x,y). The solid color values corresponding to the grabbed solid color test image may be stored in a matrix W(x,y). The microdisplay non-uniformities may be corrected by calculating a corrected image matrix C(x,y)=I(xy)·Gw/W(x,y), where Gw is a nominal all-white gray shade. The step of determining an equivalent driving voltage may be found by calculating an equivalent driving voltage from each of the normalized gray zone locations, their respective gray shades and the gamma table so as to obtain a set of electro-optical (E-O) response measurement values.

Sub-pixel defects are the ones smaller than the size of a display pixel. The detector sampling rate for the minimum sub-pixel defect should satisfy the Nyquist sampling rule. By modeling a sub-pixel defect as a local non-uniformity, a near neighborhood algorithm may be used to detect it. According to another exemplary embodiment of the present invention, the method for subpixel detection include the steps of: performing a dark alignment of a liquid crystal microdisplay under test; performing a camera fuducial alignment; scanning a plurality of sections of the liquid crystal microdisplay under test to acquire a plurality of camera images representing a white image, a fine-tuned alignment image, a gray image and a black image for each of the plurality of sections; normalizing each of the acquired plurality of camera images with camera calibration images; detecting subpixel defects from the white, gray and black images by doing neighborhood comparisons of the plurality of sections of the liquid crystal microdisplay under test; sampling the plurality of camera images so as to generate maps of pixels of the liquid crystal microdisplay under test and stitching the maps together; and detecting pixel defects from the maps of pixels using neighborhood comparisons. The step of sampling the plurality of camera images is done within the Nyquist sampling rule. Each gray zone size, shape and spatial arrangement may be user defined.

Sub-pixel defects can happen anywhere in the display, they are not restricted to alignment on pixel boundaries. By not quantizing the sub-pixel defects in terms of change to the average display pixel value, but in terms of camera pixel value, the data avoids two forms of decimation. The first decimation is the potential division of a defect between two display pixels. The second decimation is the averaging of the camera pixels detecting the defect at the display pixel location with those not detecting the defect at that location. By avoiding these two decimations the system is able to maintain the Nyquist sampling requirements. This is a distinguishing novelty to the existing known method that has difficulties with defects that occur on the inter-pixel gaps and sub-pixel defects. Note that at the display boundary the neighborhood is aligned within the active area.

Other technical advantages of the present disclosure will be readily apparent to one skilled in the art from the following figures, descriptions, and claims. Various embodiments of the invention obtain only a subset of the advantages set forth. No one advantage is critical to the invention.

### BRIEF DESCRIPTION OF THE DRAWINGS

A more complete understanding of the present disclosure and advantages thereof may be acquired by referring to the following description taken in conjunction with the accompanying drawings, wherein:

FIG. 1 is a schematic diagram of an optical configuration for a CCD area camera based testing system for determining LC microdisplay defects, according to the present invention;

FIG. 2 is a gray chart of horizontal and vertical rectangular gray zones;

FIG. 3 is a gray chart with regions of interest;

FIG. 4 is a graphical representation of a typical E-O curve;

FIG. 5 is a simplified concept of functionality defect testing, according to the present invention;

FIGS. 6A, 6B and 6C are schematic representations of focusing and mounting arrangements for a device under test and a camera/lens arrangement;

FIG. 7 is a graphical representation of LC display contrast as a function of optical axis angle;

FIG. 8 is a graphical representation of defect visibility as a function of theta (rotational angle);

FIG. 9 is a graphical representation of reflectance as a function of applied voltage in LCoS microdisplays;

FIG. 10 is a schematic representation of a device under test being scanned; and

FIG. 11 is a schematic representation of the display of a device under test having a bright defect.

While the present invention is susceptible to various modifications and alternative forms, specific exemplary embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

The present invention is directed to a LC microdisplay test method and system. Another LC microdisplay tester that could benefit from the present invention is more fully described in commonly owned co-pending non-provisional U.S. patent application Ser. No. 10/072,456, entitled “System and Method for Testing a Display Device” by Smith et al., filed Feb. 7, 2002, which claimed priority to provisional U.S. patent application Ser. No. 60/267,443, filed Feb. 8, 2001, both of which are hereby incorporated by reference herein for all purposes.

Referring now to the drawings, the details of preferred embodiments of the invention are schematically illustrated. Like elements in the drawings will be represented by like numbers, and similar elements will be represented by like numbers with a different lower case letter suffix.

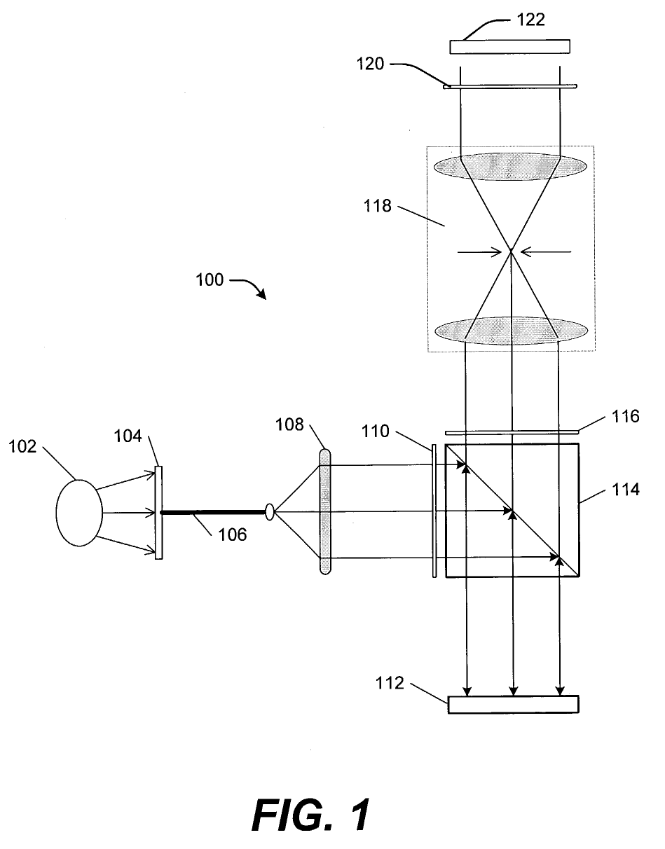

Referring to FIG. 1, depicted is a schematic diagram of an optical configuration for a CCD sensor based camera testing system for determining LC microdisplay defects. The testing system is generally represented by the numeral 100. A light source 102 emits light that is color filtered through a color filter 104. The light from the light source 102 which passes through the color filter 104 is transmitted on light guide 106 to a collimator 108. The color filter 104 wavelength band may correspond to either of the visible red/blue/green color bands, typical found in color microdisplay applications.

Light from the collimator 108 is polarized through a linear polarizer 110 and then enters a beam splitter 114, e.g., a polarizing beam splitter (PBS) or a normal beam splitter. The beam splitter 114 directs the polarized light toward a reflective liquid crystal on silicon (LCoS) microdisplay “device under test” (DUT) 112.

The DUT 112 is connected to test driving electronics (not shown) for creating grayscale patterns required by the tests, according to the present invention. The driving electronics may take video image inputs from a test computer (not shown). There may be one to three gamma tables (not shown) in the driving electronics, which transform the input video gray shades into driving voltages in a lookup-table type of mapping function G(v). The DUT 112 reflects the polarized light from the beam splitter 114. The beam splitter 114 passes the reflected light from the DUT 112 having a certain polarization to an analyzer 116 (a linear polarizer). The analyzer 116 passes the polarized light from the beam splitter 114 to a magnification lens system 118 having an F stop. The magnified light image from the magnification system 118 then (optionally) passes through a photopic filter 120 before being sensed by a CCD detector 122. The optics of the CCD detector 122 are calibrated for best flat-field correction. The display face of the DUT 112 and the optics of the CCD detector 122 are stationary with respect to each other while the measurements take place.

Test pattern images are sent to the DUT 112 for display through the driving electronics. The gray chart test image may consist of n sub-regions, wherein each of which renders a different gray level (shade) G. For example, a 1280 pixels by 1024 pixels (1280×1024) display of the DUT 112 may be divided into 16×16 rectangular sub-regions, each of which can be driven with a gray level ranging from 0-255. Such a sub-region may be called a gray zone. The size, shape and the spatial arrangement of those gray zones can be user defined, as far as they are not overlapping. Typically, gray zones of the same size and shape are preferred.

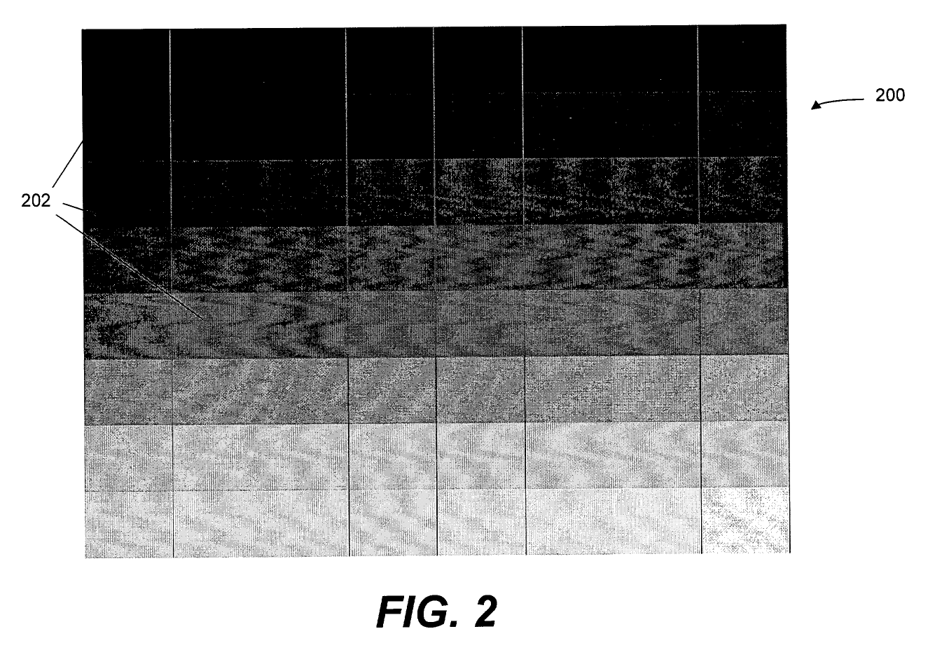

Referring now to FIG. 2, a gray chart 200 is depicted. Gray chart 200 comprises a regular arrangement of rectangular gray zones 202 in a horizontal and vertical manner. The range and the steps of the gray levels (shades) for the gray zones 202 may be user definable, and evenly stepped gray levels are preferred. Note that if the gray levels are evenly stepped, then the voltages required from the driving electronics to produce the gray levels are not usually evenly stepped voltages.

While the test pattern image is displayed on the DUT 112, the CCD detector 122 acquires an image I(x, y) of the DUT 112. In addition, a solid white test image is displayed by the DUT 112 and the second, white camera image W(x, y) is acquired. The second image, W(x, y), may be used to compensate for possible non-uniformity of the DUT 112 display. If a display of the DUT 112 is perfectly uniform, the gray level intensities of the pixels of the CCD detector 122 correlate to the rendered brightness of the corresponding display pixels of the DUT 112 display. When display non-uniformity exists, which is typical, the non-uniformity should be corrected. This correction is in addition to the flat-field correction of the camera optics of the CCD detector 122. Assuming W(x, y) represents the nominal all-white gray shade Gw (e.g., gray shade number 255), then a corrected image C(x, y) may be determined using the following formula:

C(x, y)=I(x, y)·Gw/W(x, y)

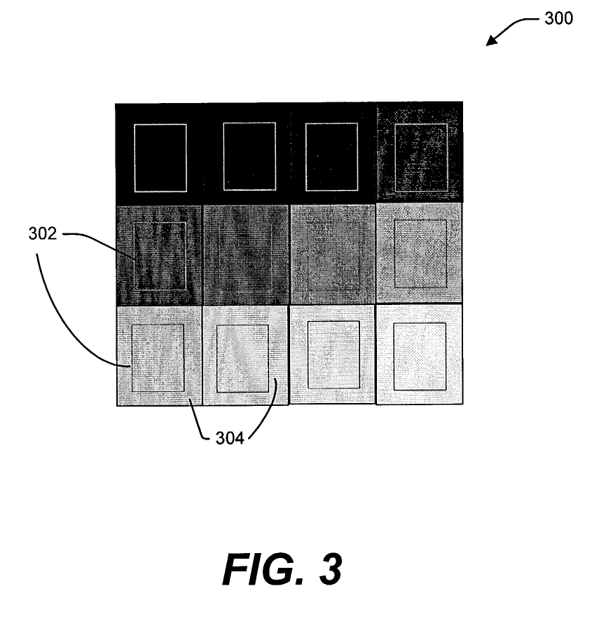

Referring now to FIG. 3, depicted is a gray chart 300 with regions of interest (ROI) 302. From the white camera image W(x, y) the active display area of the DUT 112 is located. The location of the active area may be obtained from other tests performed by the system. Using the known positions of each gray zone 304 of gray chart 300, the ROI 302 is placed inside each gray zone 304. A ROI 302 is typically centered in a gray zone 304 and preferably is smaller than the zone 304 so as to clear the borders between the zones 304. The average intensity B(g) of the pixels within the ROI 302 is calculated from the corrected image C(x, y).

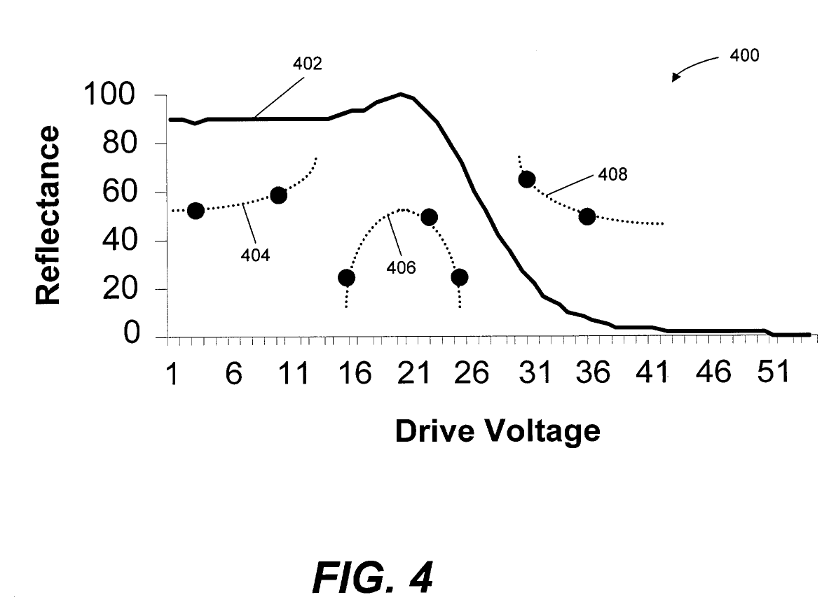

Referring now to FIG. 4, depicted is a graphical representation 400 of a typical E-O curve 402. A gray shade index g corresponds to the driving voltage that generates the gray shade through the gamma table, i.e., g=G(v). For n ROIs in n gray zones, index g has a range of 0 . . . n. The measured display brightness B(g), g=0 . . . n, represents the E-O response of the DUT, i.e., a discrete set of the E-O response data B(g)=B(G(v))=B(v), v=0 . . . n. A continuous curve may be fit from the data set B(v). The fitting shown here requires exponential curves 404 and 408 and parabolic curve 406. Brightness B(g) is the same as reflectance. In FIG. 4, reflectance is represented on a scale of 0 to 100 along the y-axis of graph 400. Drive voltage, v, is represented on the x-axis of graph 400.

Using the measured data B(g), g=0 . . . n from typical E-O curve 402, the maximum brightness Bmax=Max(B(g), g=0 . . . n) may be found. From the g value corresponding to Bmax, the driving voltage Vbright can be obtained through the inverted mapping of v=G⁻¹(g). The inverted mapping is simply looking up the gamma table. If the gray step is coarse or no E-O curve fitting is performed, a more accurate value of Bmax may fall into a range of [B(v1), B(v2)] in the vicinity of searched Bmax. Under a reasonable assumption on the shape of the E-O response curve 402, the more accurate Bmax value can be obtained by an interpolation. Similarly, if an E-O response at a percentage of the maximum brightness Bp=Bmax*a% is desired, the correspondent g is searched, and Vbright is mapped. Due to the discrete nature of the gray shade g and measured brightness B(g), the desired Bp and its Vp falls into a range of [B(v1), B(v2)]; therefore, an interpolation may be performed, which could be any appropriate interpolation such as parabolic interpolation. The interpolation again accords to a reasonable assumption on the shape of the E-O response curve 402. ***If the Vbright or Vp is the main purpose of the E-O response measurement, a further fine tuning of the measurement may be performed. For example, repeating the steps in the method of testing for LC microdisplay defects (Summary of the Invention) described above with a different gray chart test image and solid gray test image. The gray test image has a gray level closer to the one generated by previously found Vbright or Vp, hence the gray level makes the flat field correction more effective. The new gray chart has clusters of gray zones evenly arranged cross the test image, with each cluster having finer steps of a gray-level through the gray zones. A Vbright or Vp can be computed from each cluster and the average of the values may give a more accurate measurement of Vbright and Vp.

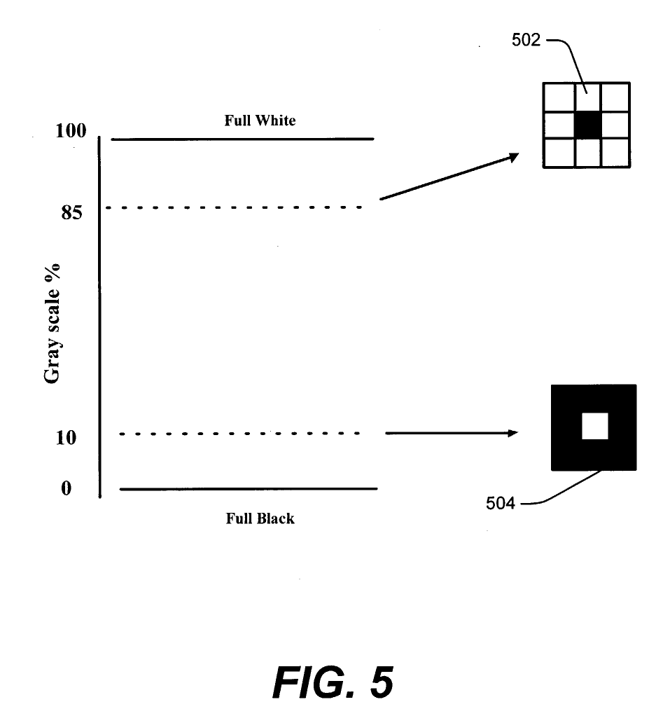

Referring now to FIG. 5, depicted is a simplified concept of pixel functionality defect testing. Pixel functionality can be tested for any gray shade within the display. The potential tests include the following: dark defects on a white image, bright defects on a black image, differences in gray shade from a nominal gray value, and the distances between defects. Each of the defects can be described as a difference in gray scale percentage from nominal. In addition, each defect can be described in terms of defect area per unit pixel size. The defect area and the difference in gray shade have an additive effect in producing an unwanted characteristic in the display. To simplify testing and the discussion, one can choose to ignore the area effect and focus on the difference in gray shade.

To illustrate the defect testing, the bounding cases of bright and dark defects may be examined. Testing for dark defects requires a white image 502 to be displayed on the DUT 112. Perturbations in the white image are measured with respect to the surrounding eight pixels. The percent difference in gray shade is compared to a threshold value. In this embodiment, the threshold is 85% gray scale. If the difference is greater than the threshold, the presence of a defect is recorded. This process may be carried out over the entire pixel array of the DUT 112.

Testing for bright defects requires a black image 504 to be displayed on the part. Perturbations in the black image are measured with respect to the surrounding eight pixels. The percent difference in gray shade is compared to a threshold value. In the embodiment illustrated in FIG. 5, the threshold is 10% gray scale. If the difference is greater than the threshold, the presence of a defect is recorded. This process is carried out over the entire pixel array of the DUT 112. Images 502 and 504 are depicted as definitive failures for, respectively, a dark defect and a bright defect.

For camera-based test systems, the sensor optics are designed to meet the minimum requirement (i.e., resolution) for defects to be detected. To allow the features in digitized images to accurately represent the real features in the DUT 112, the sampling rate of the sensor must satisfy the Nyquist sampling criteria. Typically, a spot defect of the smallest size of interest may be covered with 3 camera pixels linearly in images, i.e., the ratio of camera pixels to the spot is 9:1 in 2D camera images. Knowing the dimension of a camera pixel, one can determine the magnification of the camera lens based on the ratio. For example, considering the minimum size of spot defects being 6 μm, and given the camera pixel pitch being 7.5 μm, the magnification of the lens will be 3.75×, i.e., M=3×7.5/6. This translates to a 36:1 ratio between camera pixels to a display pixel, with 12 μm display pixel pitch.

For small format displays, such as QVGA displays, the entire display may be imaged within the detector's field of view. For higher resolution displays, e.g., 1920×1200 as used in high definition television (HDTV), it is not practical to use extremely high-resolution sensors that maintain a good spatial sampling rate. Instead, a reasonably high-resolution camera CCD sensor 122 may be employed, which has a field of view smaller than the display active area. Consequently, to view the whole display, a relative motion between the DUT 112 and the sensor 122 is required so that the 9:1 ratio is maintained. In the test system there are X-Y stages, a theta stage and motion controls.

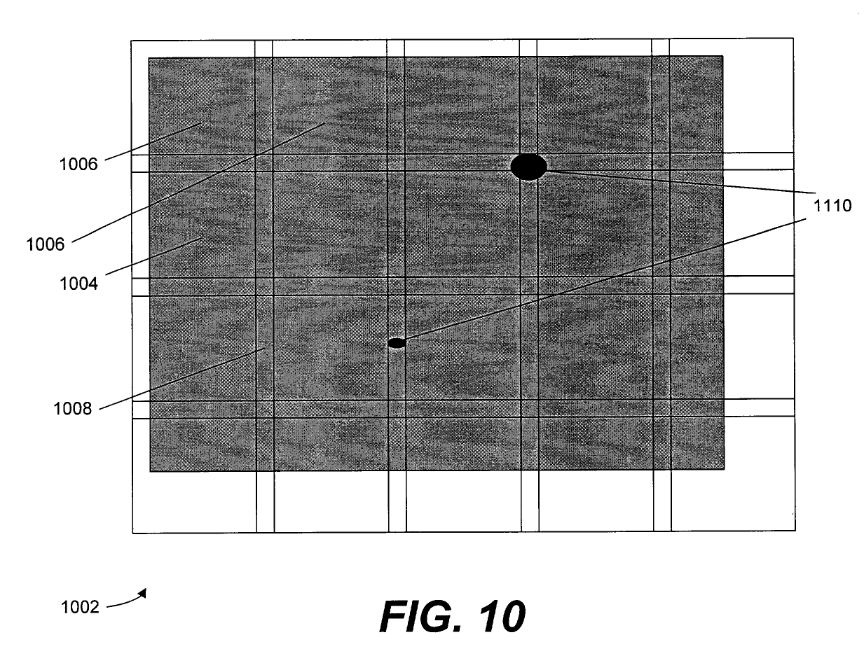

Referring now to FIG. 10, depicted is a display of a DUT 1002 being scanned by a camera (not shown) with a small field of view. Display active area 1004 is within an image tile 1006. The CCD camera uses overlapping images to scan the display of DUT 1002. Overlapping area 1008 lies between image tiles 1006. In an exemplary embodiment, the display of DUT 1002 has defects 1110.

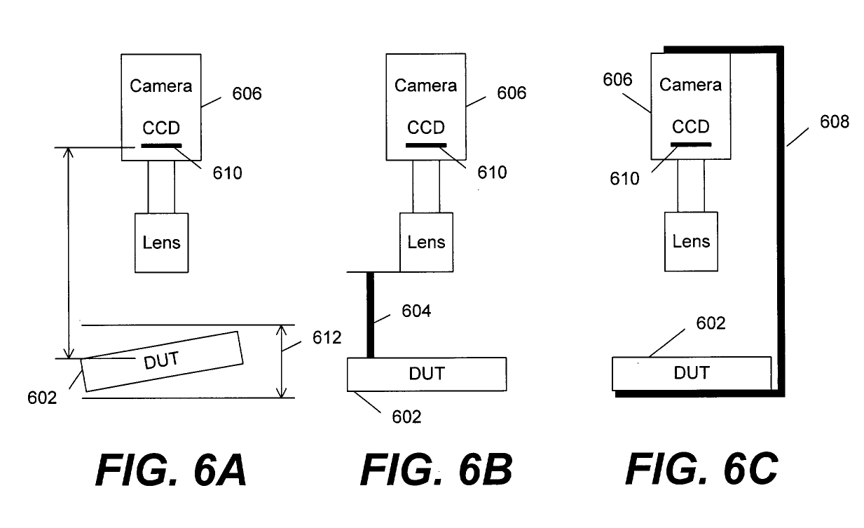

Referring now to FIGS. 6A, 6B and 6C, depicted are focusing and mounting arrangements for a device under test (DUT) 602 and camera 606 having a CCD sensor 610. The CCD sensor 610 optics have a small field of view for a good sampling rate and a high f/# when the size of the minimum defects of interest is small, such as in the case of sub-pixel defects. Consequently, the CCD sensor 610 optics will have a limited depth of field (DOF) 612 and the presentation of a DUT 602 to the CCD sensor 610 will be critical. The DUT 602 should be in the focus plane of the camera 606 and the plane of the display of DUT 602 must be substantially parallel to the plane of the CCD sensor 610 over the inspection area.

Parallelism is important. In some cases, a test system has an auto-focusing function and performs one point focusing at the center of the display of the DUT 602. To guarantee that the DUT 602 is in focus everywhere apart from the center, tilting should be controlled within the depth of field 612, as illustrated in FIG. 6A. In this respect, there are two preferable type of designs for the DUT 602 presentation mechanism, top mount and bottom mount as illustrated in FIGS. 6B and 6C, respectively.

The top mount of FIG. 6B has a short mechanical link 604 between the top of the DUT 602 and the camera 606, while the bottom mount of FIG. 6C has a longer mechanical link 608. When a very precise measurement requirement of the DOF 612 is specified, the top mount is preferred because the short mechanical link 604 will introduce less tolerance stack. Otherwise, the bottom mount is preferred due to ease of implementation. In both cases, the reference plane at either the top or the bottom of the DUT 602 should preferably be leveled to be parallel to the CCD sensor 610 plane, which can be achieved by observing the focus at various acquired images. In the display application, the reflective liquid crystal on silicon (LCoS) device (DUT 602) is commonly top-mounted. Thus, the properly-designed display system does not need to address this challenge.

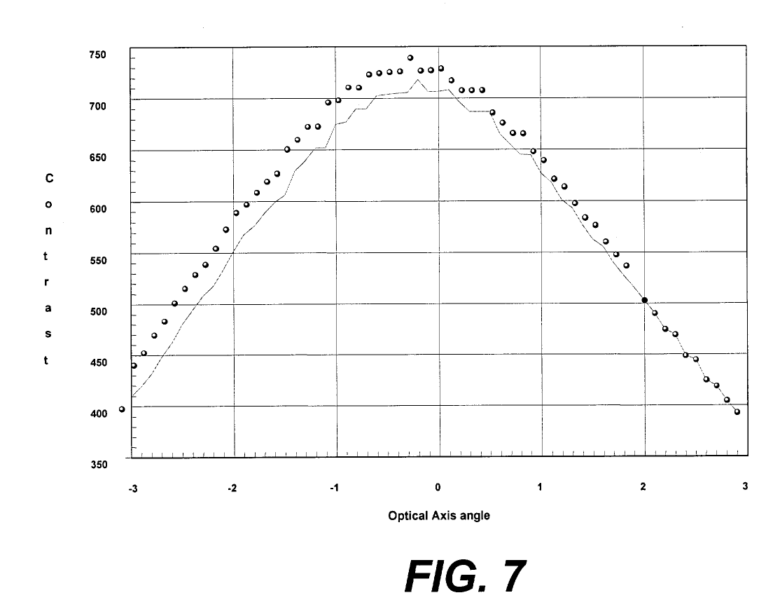

Referring now to FIG. 7, depicted is a graphical representation of display contrast as a function of optical axis angle. LCoS devices are subject to a peak in contrast as a function of optical axis. For a normally-white liquid crystal mode, this peak is largely a function of the brightness minimum in the black state. Contrast specification demands awareness of this behavior in the test environment. Equally important, this behavior affects defect visibility in the dark state within the test environment. In addition, this effect can permeate display systems that include a quarter wave plate as part of the optic chain.

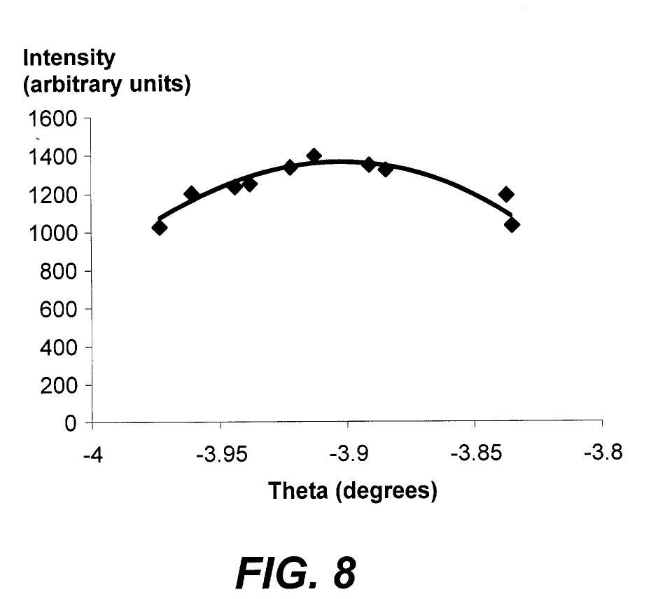

Referring now to FIG. 8, depicted is a graphical representation of defect visibility as a function of theta (rotational angle). To successfully test bright defects for normally-white LCoS devices, the defect test preferably includes a planar theta adjustment. This theta adjustment essentially maximizes the defect visibility (or defect contrast). In the display system, the maximization of contrast through the adjustment of a quarter wave plate produces a similar response in defect visibility. This effect is shown for bright defect visibility as a function of theta. Zero degree theta refers to the test system optical axis.

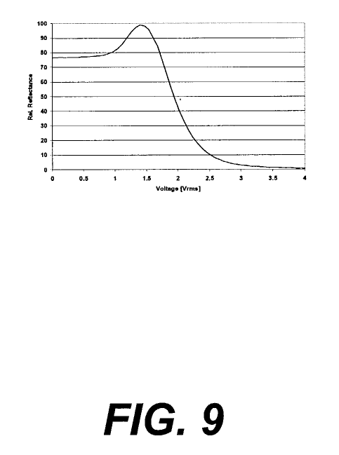

Referring now to FIG. 9, LCoS devices are subject to a peak in reflectance as a function of applied voltage. For a normally-white display device, a typical room temperature response is shown. The reflectance specification requires awareness of this behavior in the test environment. Equally important, this behavior affects defect visibility in the bright state within the test environment. In addition, this effect impacts the display systems because the user optimizes the voltage to achieve peak brightness.

To successfully test dark defects for a normally-white LCoS device, the defect test preferably includes a peak brightness-voltage (Vbright) routine. The shape of the curve in FIG. 9 requires the splicing of three curve fits and, correspondingly, defines the need for a minimum of seven data points to start an iterative search routine. However, the use of the display as part of the test system permits a rapid finding of the peak voltage through utilization of a gray chart test image that covers the range of voltages through the peak in the electro-optic (E-O) response curve.

The voltage effect is especially important for observing bright defects in the test system. In an exemplary device embodiment, the relationship in defect intensity (arbitrary units) for comparing 375 (R²=0.92) defects as a function of voltage may be described as follows:

Intensity of defect at 6V=0.95*Intensity of defect at 3.75 V−7.9

Also in an exemplary embodiment, there may be a factor of five times more defects in the deep gray condition. In developing test routines, the test system black level is related to the display system black level.

To an area optical sensor and to human eyes in projection applications of LCOS microdisplays, sub-pixel defects appear as phenomena of very local non-uniformity, although there are many causes for sub-pixel defects. By rendering a solid gray shade screen onto the display, with white and black as two special cases at extremes, the sub-pixel defects show up as bright spots, dark spots and gray spots. As the display pixels have a less than 100% fill factor, there are other small features such as inter-pixel gaps, vias and spacers. The minimum size of sub-pixel defects of interests in a gray screen is larger than the size of those small features. Note that spacer clusters may form sub-pixel defects.

As a sub-pixel defect is modelled as a local non-uniformity, the defect can be detected by an image processing algorithm similar to the pixel defect detection algorithm. Instead of using mapped display pixel, the algorithm takes a camera pixel under test and compares it with the camera image pixels in its near neighborhood. If the intensity of the pixel under test is significantly different from its neighboring pixels, a local non-uniformity is detected. A threshold can be set for the difference so to signify if the pixel under test represents a candidate sub-pixel defect. The size of the neighborhood is user-definable, typically 7×7˜15×15. A neighborhood size larger than a display pixel size in the image is preferred. This process generates a number of salient camera pixels that have be marked as candidate sub-pixels defects. Note that there is no need of alignment between the camera pixels and display pixels.

In some cases, this process is sufficient to identify sub-pixel defects. In other cases, each salient pixel is further examined within the vicinity of the other candidate pixels. If one or more salient pixels are adjacent or very close to the salient pixel under examination, a cluster is identified at the pixel under examination. The sum of gray-level differences of all salient pixels in a cluster is the energy of the cluster. Thresholding of the cluster energy yields identification of a sub-pixel defect.

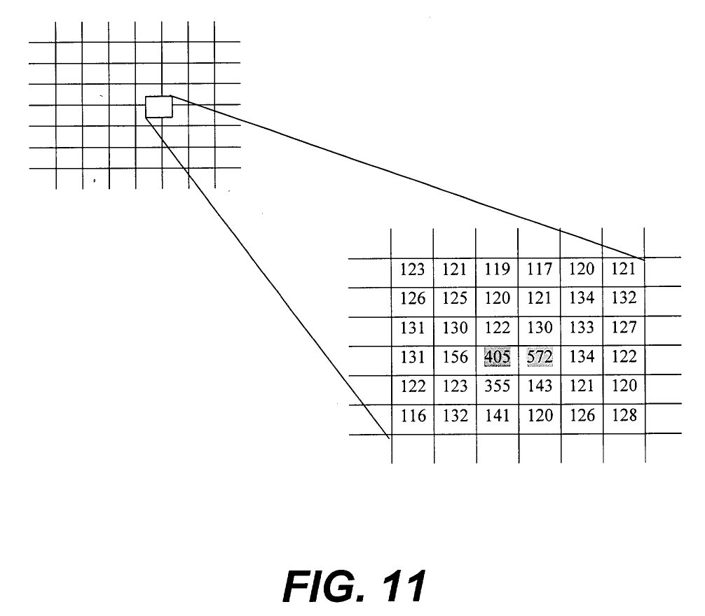

Referring now to FIG. 11, depicted is a schematic representation of a display of a DUT with a bright sub-pixel defect. Groups of camera pixels with intensity values are shown at lower right, covering a part of 4 display pixels at top left. The bright defect is identified by finding the subgroup of camera pixels that have higher intensity values than their surrounding pixels. Similarly, a dark sub-pixel defect is identified by finding a subgroup of pixels having lower brightness values than ones of their surrounding subgroups.

The invention, therefore, is well adapted to carry out the objects and attain the ends and advantages mentioned, as well as others inherent therein. While the invention has been depicted, described, and is defined by reference to exemplary embodiments of the invention, such references do not imply a limitation on the invention, and no such limitation is to be inferred. The invention is capable of considerable modification, alternation, and equivalents in form and function, as will occur to those having ordinarily skills in the pertinent arts and having the benefit of this disclosure. The depicted and described embodiments of the invention are exemplary only, and are not exhaustive of the scope of the invention. Consequently, the invention is intended to be limited only by the spirit and scope of the appended claims, giving full cognizance to equivalents in all respects.

What is claimed is:

1. A method of fast electro-optical (E-O) response measurement for liquid crystal microdisplays, comprising the steps of:
loading a gamma table into a display drive electronics, the display drive electronics being adapted for driving a liquid crystal microdisplay under test, the gamma table being appropriate for the liquid crystal microdisplay under test;
displaying a test image of a gray shade chart on the liquid crystal microdisplay under test, the gray shade chart having a plurality of gray shades;
grabbing a camera image of the gray shade chart test image displayed on the liquid crystal microdisplay under test;
locating a global region of interest (ROI) from the grabbed gray shade chart test image, wherein the global ROI represents an entire active area of the liquid crystal microdisplay under test;
computing gray zone locations by combining the location of the global ROI with locations of the plurality of gray shades;
placing a local ROI within each of the gray zone locations;
calculating an average gray level intensity, Bi, for each of the gray zone locations; and
calculating an equivalent driving voltage from each of the gray zone locations, their respective gray shades and the gamma table so as to obtain a set of electro-optical (E-O) response measurement values.

2. The method according to claim 1, further comprising the step of determining a required driving voltage for a gray level intensity by using the set of E-O response measurement values.

3. The method according to claim 1, further comprising the steps of:
displaying a solid color test image on the liquid crystal microdisplay under test;
grabbing a camera image of the solid color test image displayed on the liquid crystal microdisplay under test;
normalizing the grabbed gray shade chart test image with the grabbed solid color test image; and
performing a flat field correction with the normalized image.

4. The method according to claim 3, wherein:
gray shade values corresponding to the grabbed gray shade chart test image are stored in a matrix I(x,y);
solid color values corresponding to the grabbed solid color test image are stored in a matrix W(x,y); and
the step of normalizing comprises the step of correcting microdisplay non-uniformities by calculating a corrected image matrix C(x,y)=I(xy)·Gw/W(x,y), where Gw is a nominal all-white gray shade.

5. The method according to claim 3, wherein the solid color is substantially white.

6. The method according to claim 3, wherein the solid color is substantially light gray.

7. The method according to claim 3, wherein the step of calculating an equivalent driving voltage comprises the step of calculating an equivalent driving voltage from each of the normalized gray zone locations, their respective gray shades and the gamma table so as to obtain a set of electro-optical (E-O) response measurement values.

8. The method according to claim 1, further comprising the steps of:
performing the steps of claim 1 with the gray shade chart test image having a plurality of gray shades closer to a gray level intensity range of interest.

9. The method according to claim 3, further comprising the steps of:
performing the steps of claims 1 and 3 with the gray shade chart test image having a plurality of gray shades closer to a gray level intensity range of interest.

10. The method according to claim 9, further comprising the step of determining a required driving voltage for a gray level intensity by using the set of E-O response measurement values.

11. A method of testing for liquid crystal microdisplay subpixel defects, comprising the steps of:
performing a dark alignment of a liquid crystal microdisplay under test;
performing a camera fuducial alignment;
scanning a plurality of sections of the liquid crystal microdisplay under test to acquire a plurality of camera images representing a white image, a fine-tuned alignment image, a gray image and a black image for each of the plurality of sections;
normalizing each of the acquired plurality of camera images with camera calibration images;
detecting subpixel defects from the white, gray and black images by doing neighborhood comparisons of the plurality of sections of the liquid crystal microdisplay under test;
sampling the plurality of camera images so as to generate maps of pixels of the liquid crystal microdisplay under test and stitching the maps together; and
detecting pixel defects from the maps of pixels using neighborhood comparisons.

12. The method according to claim 11, wherein the step of sampling the plurality of camera images is done within the Nyquist sampling rule.

13. The method according to claim 1, wherein each gray zone size, shape and spatial arrangement may be user defined.
